(19) United States
(12) Patent Application Publication
(10) Pub. No.: US 2018/0137850 A1
(43) Pub. Date: May 17, 2018

(54) SOUND BARRIER PANEL AND SYSTEM

(71) Applicant: SOUND FIGHTER SYSTEMS, LLC, Shreveport, LA (US)

(72) Inventors: Patrick W. HARRISON, Shreveport, LA (US); Ben J. BURKETT, Shreveport, LA (US); Murray R. STACY, Flower Mound, TX (US)

(21) Appl. No.: 15/354,537

(22) Filed: Nov. 17, 2016

(51) Int. Cl. G10K 11/168; E04B 1/84; E04B 1/82; E04B 1/94

(52) U.S. Cl. CPC G10K 11/168; E04B 1/84; E04B 2001/8414; E04B 1/94; E04B 1/8209

(57) ABSTRACT

A sound barrier panel comprising a substantially planer first wall, with a plurality of apertures defined in the first wall, a non-apertured second wall, a crown connecting the first wall to the second wall, a base connecting the first wall to the second wall, a panel interior defined by a spacing between the first wall, the second wall, the crown, and the base, a sound absorbing material disposed in the panel interior, and the second wall being contoured such that at least one continuous gap is formed between an inner surface of the second wall and the sound absorbing material, wherein the first wall, the second wall, the crown, and the base are formed of a pultruded material.

### BACKGROUND OF THE INVENTION

With increased mechanization and higher density living, more people are subjected to excessive noise from automobiles, roadways, airports, industrial facilities, and various machines. This problem has inflicted society for scores of years without adequate solution. Attempts to address the high noise environments being generated have had limited results because of inadequate sound absorption, inadequate strength, inadequate environmental robustness, and difficult sound barrier system construction, just for example. For the foregoing reasons, there is a pressing, but seemingly irresolvable need for a sound barrier panel and system.

### SUMMARY OF THE INVENTION

Wherefore, it is an object of the present invention to overcome the above mentioned shortcomings and drawbacks associated with the current technology. The present invention is directed to sound barrier panels and sound barrier systems. The sound barrier panels comprise a substantially planer first wall, with a plurality of apertures defined in the first wall, a non-apertured second wall, a crown connecting the first wall to the second wall, and a base connecting the first wall to the second wall. A panel interior is defined by a spacing between the first wall, the top wall, the crown, and the base. A sound absorbing material is disposed in the panel interior. The second wall is contoured such that at least one continuous gap is formed between an inner surface of the second wall and the sound absorbing material. The first wall, the second wall, the crown, and the base are formed of a pultruded material.

Additional embodiment of the sound barrier panel include a tongue defined on one of the crown and the base, and a groove defined on the other of the crown and the base, wherein the tongue matingly fits within the groove.

Additional embodiments of the sound barrier panel include the tongue fitting within the groove with a transition fit.

Additional embodiments of the sound barrier panel include a shoulder adjacent to the tongue and a foot adjacent to the groove.

Additional embodiments of the sound barrier panel include the tongue being one of one half and one third of the width of the sound barrier panel.

Additional embodiments of the sound barrier panel include the second wall having at least one indentation, the indentation spacing the sound absorbing material from a planar portion of the second wall creating the at least one gap.

Additional embodiments of the sound barrier panel include a sum volume of the at least one gaps preferably occupying between 3.0% and 35.0% of the panel interior.

Additional embodiments of the sound barrier panel include the apertures covering between 22% and 30% of a surface area of the first wall.

Additional embodiments of the sound barrier panel include the apertures being circular and having a diameter between ¼ inches and 1¼ inches.

Additional embodiments of the sound barrier panel include a plurality of uninterrupted wall columns of material on the first wall uninterrupted by apertures, the uninterrupted wall columns extending along the first wall from above an uppermost aperture to below a bottommost aperture.

Additional embodiments of the sound barrier panel include at least one of the plurality of uninterrupted wall columns being between ½ and 1 1/10 as wide as a diameter of the apertures.

Additional embodiments of the sound barrier panel include the sound barrier panel being flame resistant.

Additional embodiments of the sound barrier panel include the first wall, the second wall, the crown, and the base being formed of fiberglass.

Additional embodiments of the sound barrier panel include the sound absorbing material being mineral wool.

Additional embodiments of the sound barrier panel include the sound absorbing material being adjacent to the first wall.

Additional embodiments of the sound barrier panel include the panel having a Noise Reduction Coefficient (NRC) measurement of above 0.95 and a Sound Transmission Class (STC) measurement of above 30.0.

Additional embodiments of the sound barrier panel include the panel measuring between 2.0 inches and 5.0 inches wide, between 6.0 inches and 24.0 inches high, and between 4 feet and 24 feet long.

Additional embodiments of the sound barrier panel include a phenolic coating over an exterior of the first wall, the second wall, the crown, and the base.

Additional embodiments of the sound barrier panel include a plurality of acoustic diffusers formed on an interior surface of the second wall.

Additional embodiments of the sound barrier panel include a cross-section of the second wall having a shiplap shape.

Various objects, features, aspects, and advantages of the present invention will become more apparent from the following detailed description of preferred embodiments of the invention, along with the accompanying drawings in which like numerals represent like components. The present invention may address one or more of the problems and deficiencies of the current technology discussed above. However, it is contemplated that the invention may prove useful in addressing other problems and deficiencies in a number of technical areas. Therefore the claimed invention should not necessarily be construed as limited to addressing any of the particular problems or deficiencies discussed herein.

### BRIEF DESCRIPTION OF THE DRAWINGS

The accompanying drawings, which are incorporated in and constitute a part of the specification, illustrate various embodiments of the invention and together with the general description of the invention given above and the detailed description of the drawings given below, serve to explain the principles of the invention. It is to be appreciated that while the accompanying drawings are drawn substantially to scale for various embodiments of the invention, the emphasis is additionally placed on illustrating the principles of the invention for other embodiments of the invention for which the drawings would not be scale representations. The invention will now be described, by way of example, with reference to the accompanying drawings in which:

FIG. 1 is a partial cutout isometric view of a sound barrier panel according to a first embodiment of the present invention partially mounted in support columns as a portion of a sound barrier system;

FIG. 2 is a sectional view of the sound barrier panel of FIG. 1 along the sectional line F2;

FIG. 3 is an isometric view of a stack of three of the panels as shown in FIG. 1, as mounted in the sound barrier system, but without the support columns shown;

FIG. 4 is a close up view of coupling of two adjacent panels in FIG. 3 shown in dashed circle F4 with the sound absorbing material omitted for clarity;

FIG. 5 is a partial front plan view of the sound barrier panel of FIG. 1;

FIG. 6 is a partial rear plan view of the sound barrier panel of FIG. 1;

FIG. 7 is a sectional view of the sound barrier panel of FIG. 5 along sectional line F7 with a first embodiment of sound diffusers disposed on the interior surface of the second wall; and

FIG. 8 is a sectional view of the sound barrier panel of FIG. 5 along sectional line F8 with a second embodiment of sound diffusers disposed on the interior surface of the second wall.

### DETAILED DESCRIPTION OF THE PREFERRED EMBODIMENTS

The present invention will be understood by reference to the following detailed description, which should be read in conjunction with the appended drawings. It is to be appreciated that the following detailed description of various embodiments is by way of example only and is not meant to limit, in any way, the scope of the present invention. In the summary above, in the following detailed description, in the claims below, and in the accompanying drawings, reference is made to particular features (including method steps) of the present invention. It is to be understood that the disclosure of the invention in this specification includes all possible combinations of such particular features, not just those explicitly described. For example, where a particular feature is disclosed in the context of a particular aspect or embodiment of the invention or a particular claim, that feature can also be used, to the extent possible, in combination with and/or in the context of other particular aspects and embodiments of the invention, and in the invention generally. The term “comprises” and grammatical equivalents thereof are used herein to mean that other components, ingredients, steps, etc. are optionally present. For example, an article “comprising” (or “which comprises”) components A, B, and C can consist of (i.e., contain only) components A, B, and C, or can contain not only components A, B, and C but also one or more other components. Where reference is made herein to a method comprising two or more defined steps, the defined steps can be carried out in any order or simultaneously (except where the context excludes that possibility), and the method can include one or more other steps which are carried out before any of the defined steps, between two of the defined steps, or after all the defined steps (except where the context excludes that possibility).

The term “at least” followed by a number is used herein to denote the start of a range beginning with that number (which may be a range having an upper limit or no upper limit, depending on the variable being defined). For example “at least 1” means 1 or more than 1. The term “at most” followed by a number is used herein to denote the end of a range ending with that number (which may be a range having 1 or 0 as its lower limit, or a range having no lower limit, depending upon the variable being defined). For example, “at most 4” means 4 or less than 4, and “at most 40%” means 40% or less than 40%. When, in this specification, a range is given as “(a first number) to (a second number)” or “(a first number)-(a second number),” this means a range whose lower limit is the first number and whose upper limit is the second number. For example, 25 to 100 mm means a range whose lower limit is 25 mm, and whose upper limit is 100 mm. The embodiments set forth the below represent the necessary information to enable those skilled in the art to practice the invention and illustrate the best mode of practicing the invention. In addition, the invention does not require that all the advantageous features and all the advantages need to be incorporated into every embodiment of the invention.

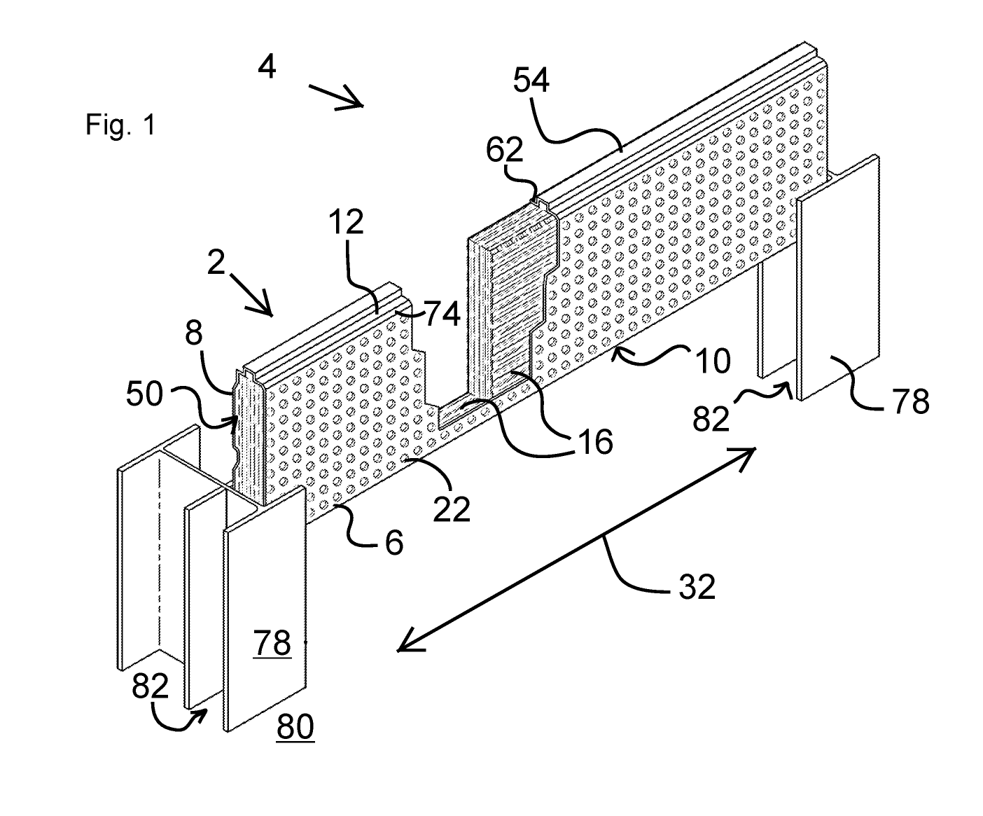

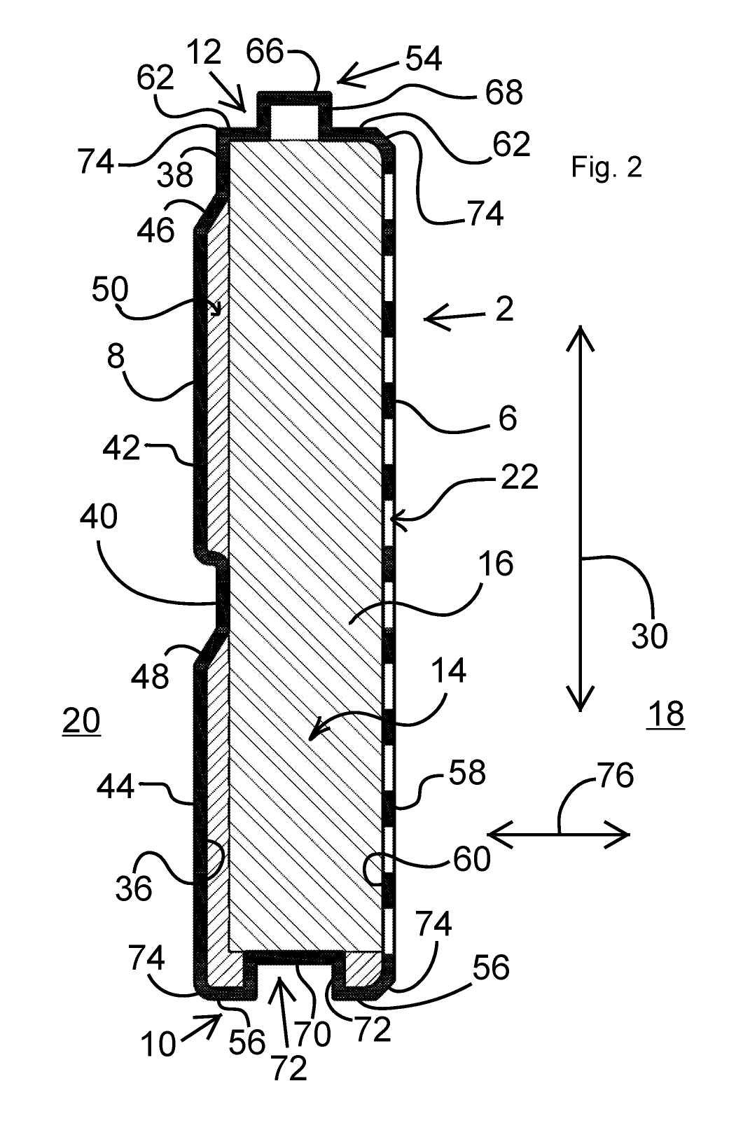

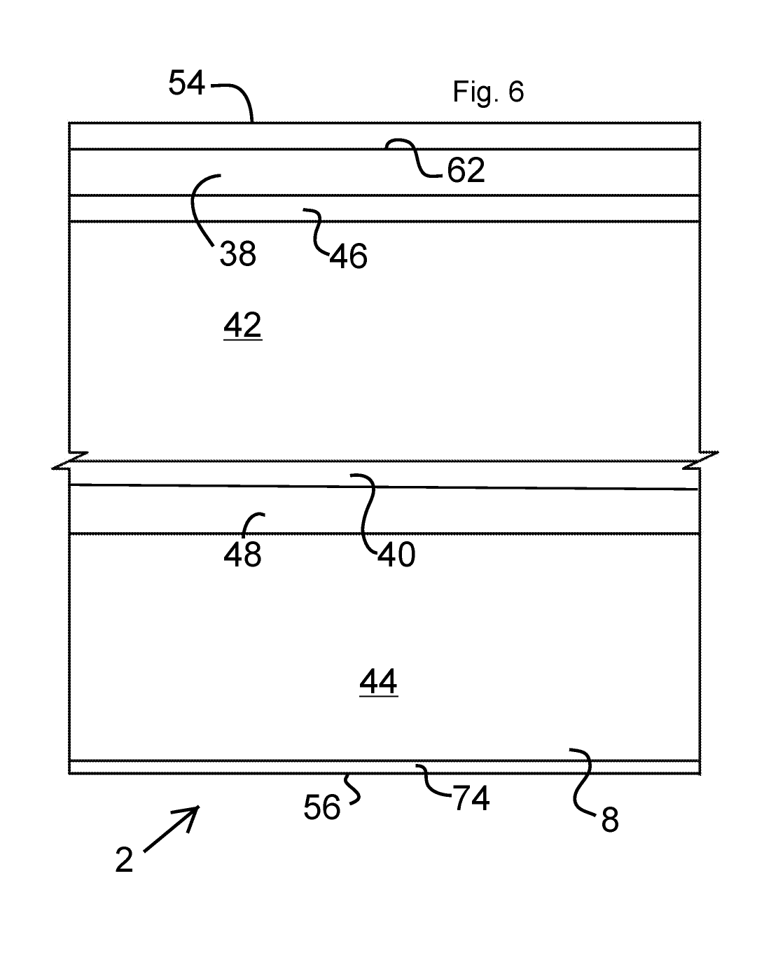

Turning now to FIGS. 1 to 8, a brief description concerning the various components of the sound barrier panel 2 and sound barrier system 4 according to present invention will now be briefly discussed. As can be seen in FIGS. 1 and 2, for example, the sound barrier panel 2 includes a first wall 6, a second wall 8 spaced from the first wall 6, and a base 10 and a crown 12 both connecting the first wall 6 to the second wall 8 and defining a panel interior 14. The first wall 6, the second wall 8, the crown 12, and the base 10 are preferably unitary of structure and formed from pultruded fiberglass, and preferably have a substantially constant cross sectional width (though variations in cross sectional width is envisioned in further embodiments). A sound absorbing material 16 is disposed in the panel interior 14. The sound barrier panel 2 and sound barrier system 4 is oriented to provide a sound barrier between a location of excessive noise 18 and a location that is to be noise protected 20.

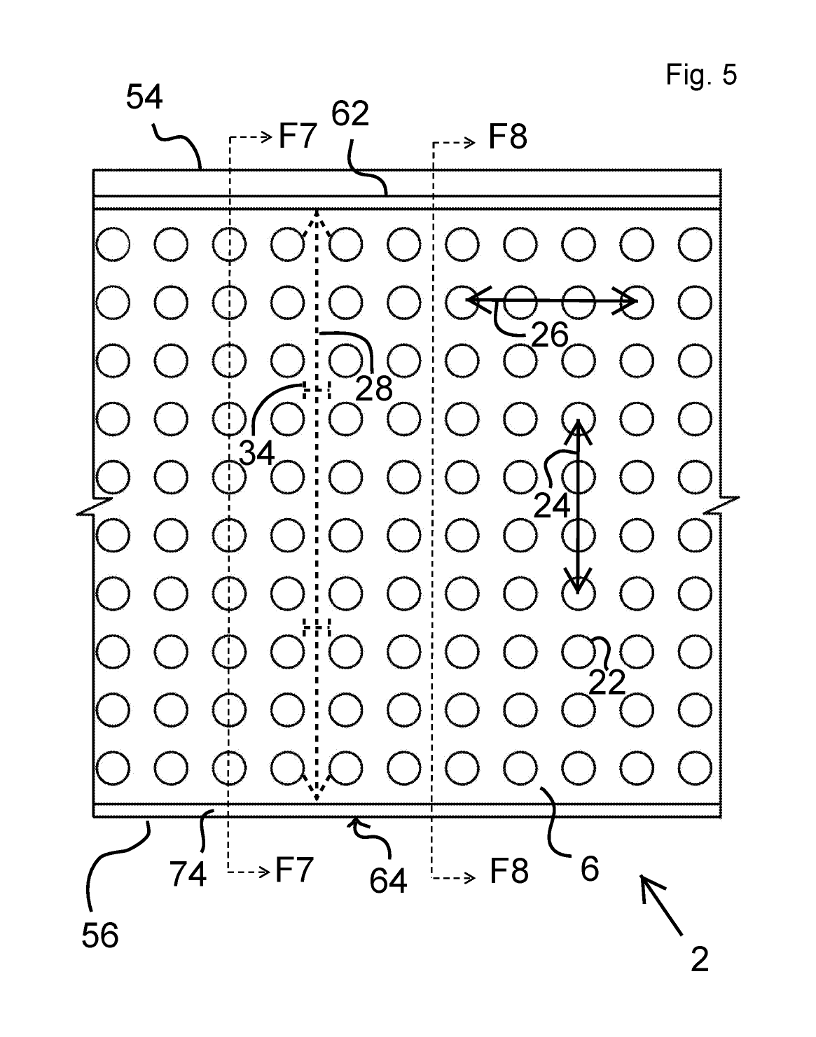

THE FIRST WALL: The first wall 6 of the sound barrier panel 2 is designed to face toward the location having excessive noise to be attenuated 18. The first wall 6 is preferably substantially planar in shape from the base 10 to the crown 12. A plurality of apertures 22 are defined in the first wall 6, and extend fully through the first wall 6 (in further embodiments that focus on reflective barrier protection for noise, the apertures 22 may be omitted from the first wall 6 and the second wall 8). The apertures 22 are preferably arranged in aperture columns 24 and aperture rows 26, preferably with substantially equal spacing between adjacent apertures 22 in each aperture column 24 and in each aperture row 26. The apertures 22 are preferably circular in shape, and have a diameter that measures preferably between ¼ inches and 1¼ inches, more preferably between ⅜ inches and ⅞ inches, even more preferably between ½ and ¾ inches, and most preferably is approximately ⅝ inches diameter. The apertures preferably occupy between 22% and 30% of the surface area of the first wall 6, more preferably between 23% and 27% of the surface area of the first wall 6, and most preferably occupy approximately 24% of the surface area on the first wall 6. Generally, the more surface area the apertures 22 occupy, the greater sound absorption, but the structurally weaker the sound barrier panel 2, and vice versa. As shown in FIG. 5, the apertures 22 are defined on the first wall 6 so as to create wall material support in a plurality uninterrupted wall columns 28 that are defined along the first wall 6 from the crown 12 to the base 10, and are preferably as wide as a distance between adjacent apertures 22. Though only one uninterrupted wall column 28 is indicated in FIG. 5, at least ten are shown in the Figure. The uninterrupted wall columns 28 are preferably aligned in the vertical direction 30. The uninterrupted wall columns 28 have a lengthwise 32 span 34 preferably between ½ and 1 1/10 as great as the diameter of the apertures 22, more preferably between 7/10 and 9/10 as great as the diameter of the apertures 22, and most preferably between 7/10 and 9/10 as great as the diameter of the apertures 22.

THE SECOND WALL: The second wall 8 faces the noise protected location 20. The second wall 8 is preferably solid and non-apperatured to help prevent noise sound waves from passing through the second wall 8, but rather reflecting off the interior surface 36 of the second wall 8 and back toward the first wall 6. In the embodiment shown, the second wall 8 has a shiplap shape, with an upper indentation 38 at an upper portion of the second wall 8 and a midway indentation 40 at a midway portion of the second wall 8. An upper planar portion 42 and a lower planar portion 44 are separated by the midway indentation 40. In the embodiment shown, an upper inclined section 46 joins the upper indentation 38 to the upper planar portion 42, and a midway inclined section 48 joins the midway indentation 40 to the lower planar portion 44. With height referencing distance in the vertical direction 30, the indentations 38, 40 preferably measure between 0.5 inches and 1.25 inches in height, more preferably between 0.75 and 1.0 inches in height, and most preferably between 0.85 and 0.93 inches in height. Proportionally, each of the shown indentations 38, 40 are preferably between 3.0% and 12.0% of the vertical expanse of the second wall 8, more preferably between 5.0% and 10.0% of the vertical expanse of the second wall 8, and most preferably between 6.5% and 7.5% of the vertical expanse of the second wall 8. The planar portions 42, 44 shown each preferably measure between 2.0 inches and 5.5 inches in height, more preferably between 3.75 and 5.0 inches in height, and most preferably between 4.2 and 4.8 inches in height. Proportionally, each the planar portions 42, 44 shown are preferably between 33.0% and 43.0% of the vertical expanse of the second wall 8, more preferably between 35.0% and 41.0% of the vertical expanse of the second wall 8, and most preferably between 38.0% and 38.5% of the vertical expanse of the second wall 8. The inclined sections 46, 48 shown preferably each measure between 0.3 inches and 0.7 inches in height, more preferably between 0.4 and 0.6 inches in height, and most preferably between 0.475 and 0.525 inches in height. Proportionally, the inclined sections 46, 48 are preferably between 2.0% and 6.4% of the vertical expanse of the second wall 8, more preferably between 3.0% and 5.4% of the vertical expanse of the second wall 8, and most preferably between 3.8% and 4.6% of the vertical expanse of the second wall 8. The number of planar portions 42, 44 and corresponding inclined sections 46, 48 and indentations 38, 40 shown in the Figures is two, but the numbers could be 1, 3, 4, or more. In further embodiments, the second wall 8 may be planar from the crown 12 down to the base 10, or some portion or portions thereof.

The indentations 38, 40 help to retain the sound absorbing material 16 at a distance from a portion of the second wall, here the planar portions 42, 44, and the inclined sections 46, 48, preferably creating one or more gaps 50 in the panel interior 14 between the second wall 8 and the sound absorbing material 16. Though a plurality of gaps 50 are shown in FIG. 2, according to additional embodiments just a single gap 50 may be present. The at least one gap 50 preferably spaces the sound absorbing material 16 between ⅛ and 1¼ inch from the interior surface 36 of the planer portions 42, 44 of the second wall 8, more preferably between 3/16 inches and 7/16 inches from the interior surface 36 of the planer portions 42, 44 of the second wall 8, even more preferably between ¼ inches and ⅜ inches from the interior surface 36 of the planer portions 42, 44 of the second wall 8, and most preferably ¼ inches and ⅜ inches from the interior surface 36 of the planer portions 42, 44 of the second wall 8. In a cross section of the sound barrier panel 2, the sum area occupied by a cross section (as shown in FIG. 2) of the at least one gaps 50 preferably measures between 2.0 and 4.0 square inches, more preferably between 2.5 and 3.5 square inches, and most preferably between 2.85 and 3.15 square inches. The sum of the volume of the at least one gaps 50 preferably occupies between 3.0% to 35.0% of the panel interior 14, more preferably occupies between 6.0% and 20.0% of the panel interior 14, even more preferably occupies between 9.0% and 13.0% of the panel interior 14, and most preferably occupies between 10.5% and 11.5% of the panel interior 14. It is understood that with embodiments utilizing sound diffusers 52, as described below, the sound diffusers 52 may occupy some of the volume of the at least one gaps 50 described above. Preferably, even with sound diffusers 52, at least a portion of at least one gap 50 would still be provided between the sound absorbing material 16 and the sound diffusers/second wall 52, 8. As described below, the at least one gap 50 between the sound absorbing material 16 and the second wall 8 forces the sound waves to move through a further medium (e.g., air) between the sound absorbing material 16 and the second wall 8, further increasing the effectiveness of the sound barrier panel 2.

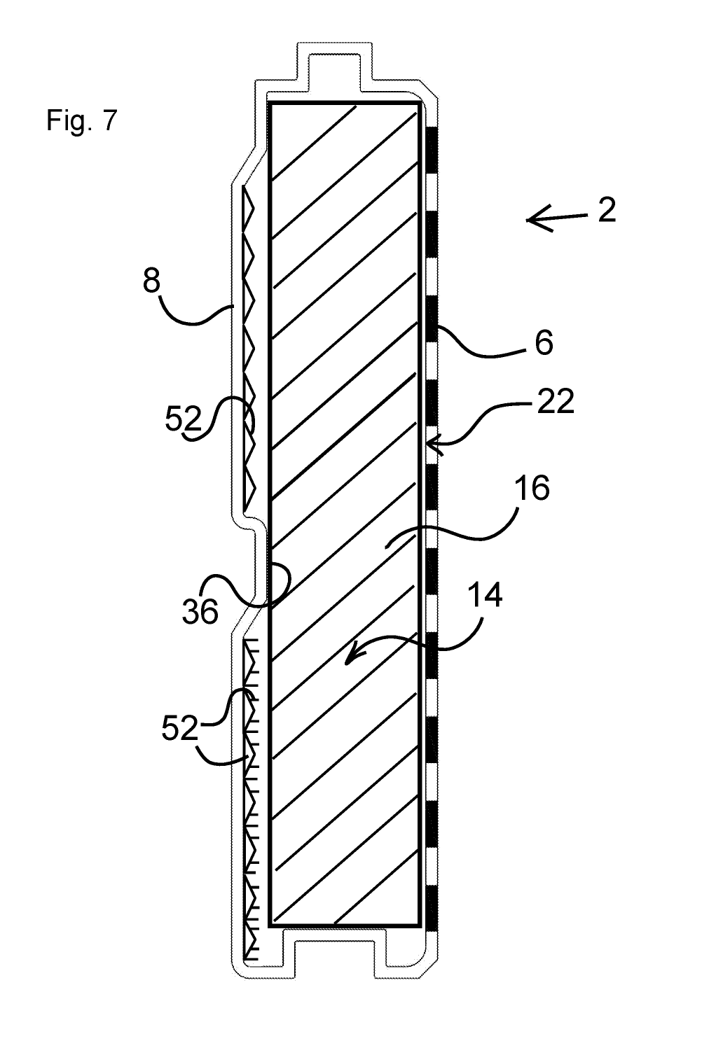

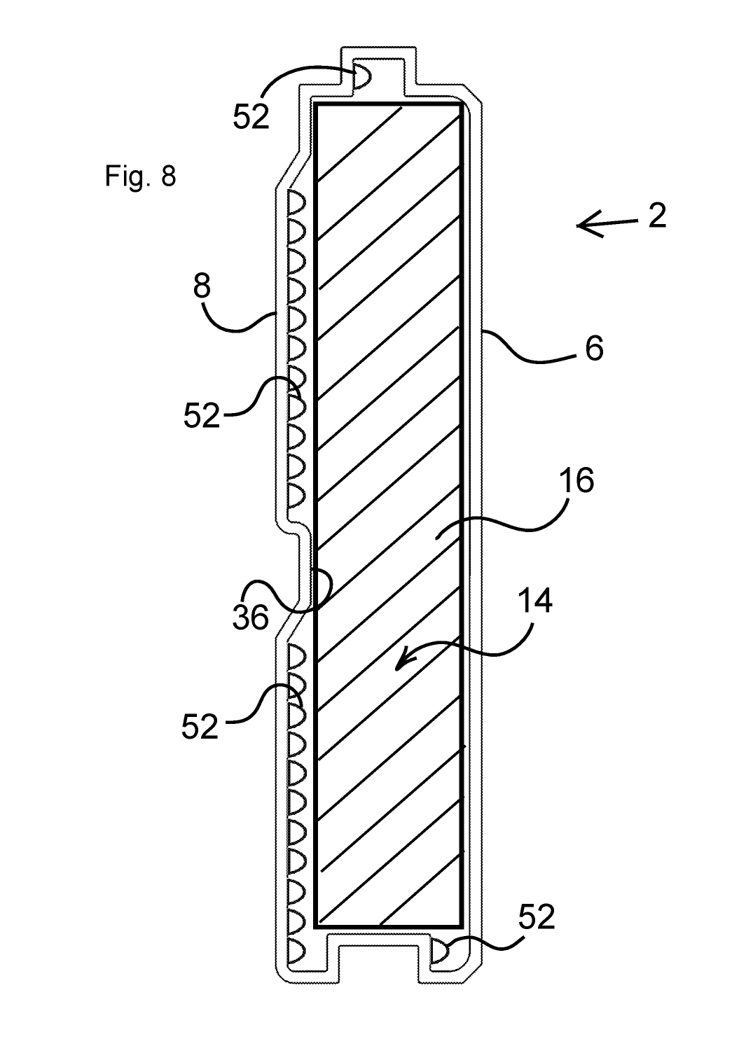

SOUND DIFFUSERS: The interior surface 36 of the second wall 8 may be smooth and substantially planar as shown in FIG. 2, for example. Alternatively, one or more sound diffusers 52 may be disposed on the interior surface 36. The sound diffusers 52 may be topographical elements like triangular extensions, as shown in the upper and lower planar portions 42, 44 of FIG. 7, orthogonal strips of material, as shown with the triangular extensions in the lower planar portion 44 of FIG. 7, semi-circle extensions, as shown in the upper and lower planar portions 42, 44, the tongue 54, and the feet 56 in FIG. 8, convex and or concave elements, or other shapes and designs, such as maximum length sequence (MLS) diffusors, quadratic residue diffusers (QRD), Cox D'Antonio modified primitive root diffusers (CDMPRD), primitive root diffusers (PRD), and numerical optimization diffuser, for example. The sound diffusers 52 preferably have a consistent cross section profile across a length of sound barrier panel 2, so that of the sound barrier panel 2 with the diffusers 52 is readily pultrudeable through the pultrusion die in a linear/lengthwise direction 32. According to a further embodiment, the sound barrier panel may include sound diffusers, including sound diffusers that extend further toward the first wall, and less sound absorbing material, or even no sound absorbing material.

The pultrusion material is preferably fiberglass, including S glass and E glass, A glass, C glass, E-CR-glass, D glass, T glass and/or R glass composite materials, but may also be other pultrudeable materials such as carbon fibers, aramid fibers, and/or Kevlar fibers for example, with a chosen resin, for example, as known in the art. The resin can also include a phenolic additive to increase fire resistance. When selecting a pultrusion material, fire resistance is a preferable quality. When combined with a fire resistant sound absorption material, and potentially a phenolic coating (including epoxy phenolic coating) on one or both of an exterior surface 58 and interior surface 60 of the sound barrier panel 2, the sound barrier panel 2 can function as a manner of a fire barrier also. The phenolic coating may also be chosen to increase strength and/or to provide for protection from UV rays and other environmental degradation.

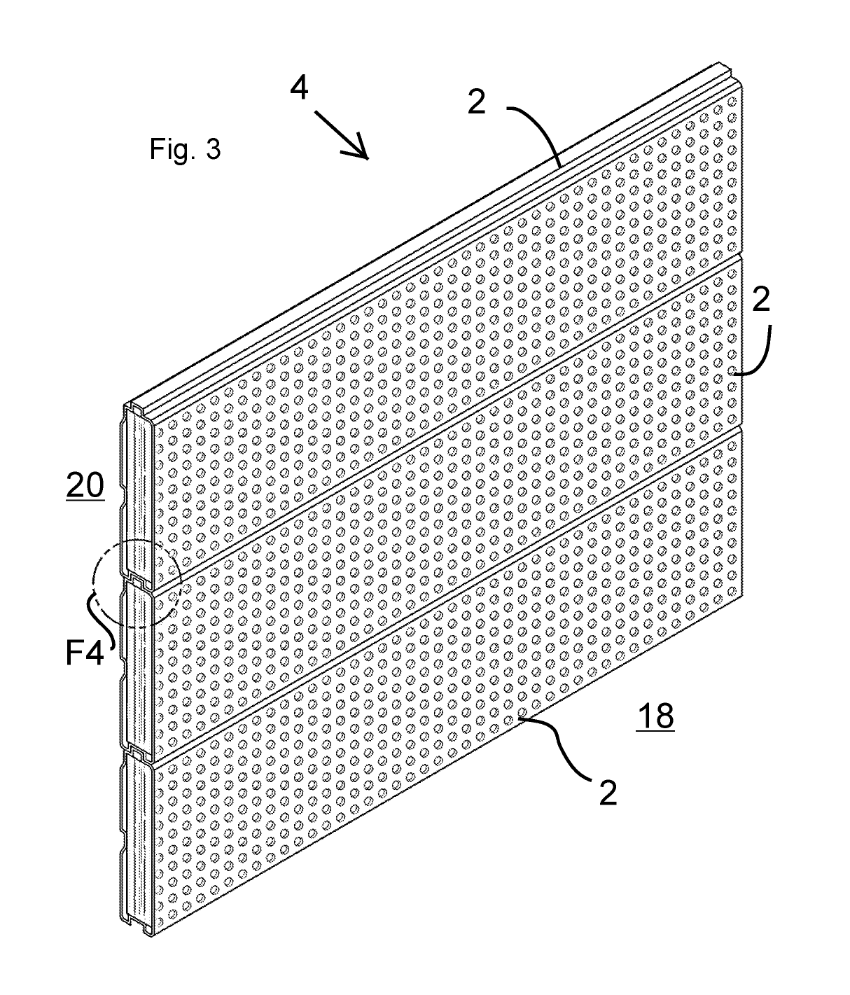

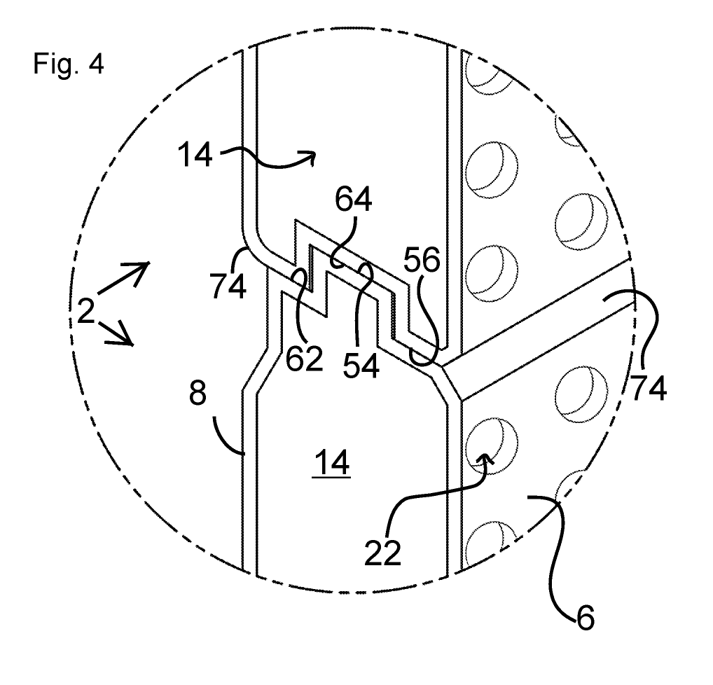

BASE AND CROWN: The crown 12 connects a top portion of the first wall 6 to a top portion of the second wall 8. The crown 12 includes an upward projecting tongue 54, which projects upwardly from panel interior 14, and preferably two shoulders 62 on either side of the tongue. The base 10 connects a bottom portion of the first wall 6 and a bottom portion of the second wall 8. The base 10 includes an upward extending groove 64, which extends upwardly into the panel interior 14, and preferably two feet 56, one on either side of the tongue 54. As shown in FIGS. 3 and 4, the tongue 54 and groove 64 are sized such that when a first sound barrier panel 2 is placed on top of a second sound barrier panel 2, the tongue 54 of the second sound barrier panel 2 fits into and preferably contacts the groove 64 of the first sound barrier panel 2, and the feet 56 of the first sound barrier panel 2 rest on and preferably contact the shoulders 62 of the second sound barrier panel 2. As described below, the tongue 54 and groove 64 stacking feature allows for additional strength for and less acoustical leakage through the stacked sound barrier panels 2 and the sound barrier system 4.

Referring to the exterior 58 of the sound barrier panel 2, the tongue 54 is preferably 0.5 inches to 1.5 inches wide, more preferably 0.75 inches to 1.25 inches wide, and most preferably 1.0 inches wide. The tongue 54 is preferably 0.25 inches to 0.75 inches high, more preferably 0.375 and 0.625 inches high, and most preferably 0.5 inches high. The width of the tongue 54 is preferably approximately twice the height of the tongue 54. The width of the tongue 54 is preferably between one half and one third of the width of the sound barrier panel 2, more preferably between three elevenths and five elevenths of the width of the sound barrier panel 2, and most preferably four elevenths of the width of the sound barrier panel 2. The width of the groove 64 is preferably between 3% and 10% wider that the width of the tongue 54, more preferably between 5% and 8% wider that the width of the tongue 54 and most preferably between 6.2% and 6.5% wider than the width of the tongue 54. The height of the groove 64 is preferably substantially equal to the height of the tongue 54. The tongue 54 and the groove 64 are both preferably substantially centered in a cross section of the sound barrier panel 2, for example, as seen in FIG. 2.

The fit between the tongue 54 and the groove 64 is preferably one of a clearance fit, a transition fit, and an interference fit (such as a press fit or friction fit), and more preferably a transition fit. The wall of the crown 12 defining the tongue 54 preferably extends orthogonally upward from the shoulder 62, and likewise, the top 66 of the tongue 54 preferably attaches orthogonally to the sides 68 of the tongue 54. In a similar manner, the groove 64 extends upward orthogonally from the feet 56 of the base 10, and the top 70 of the groove 64 attaches orthogonally to the sides 72 of the groove 64. This geometry creates a sound pathway at the connection between two sound barrier panels 2 (such as a stack as described above) that forces sound waves to turn four right angles to pass from the excessive noise location 18 through the sound barrier panels 2 to the noise protected location 20. In connection with the preferably secure fit between the tongue 54 and groove 64, this geometry appears to contribute to a dramatic reduction in sound transmission from the excessive noise location 18 to the noise protected location 20.

Though a single tongue 54 and a single groove 64 is shown in the Figures, it is anticipated that two or more tongues 54 may be disposed on the crown 12 and a matching two or more grooves 64 may be disposed on the base 10. Additionally, though the tongue 54 is shown and preferred to be located on the crown 12 and the groove 64 on the base 10, one or more tongues 54 may additionally or alternatively be disposed on the base 10, and a correspondingly mating one or more grooves 64 may additionally or alternatively be disposed on the crown 12. The greater number of tongues 54 and grooves 64, and the corresponding additional orthogonal turns in a cross section sound pathway would dissipate sound transmission further, but the additional tongues 54 and grooves 64 may decrease the structural integrity of the sound barrier panel 2 to sound barrier panel fit 2.

Where the first wall 6 and the second wall 8 connect to the crown 12 and the base 10, a transition zone 74 is formed in the first wall 6 and the second wall 8. The transition zone 74 may be different shapes depending upon the technical and aesthetic requirements. The transition zone 74 may be a chamfered transition zone 74, as shown between the first wall 6 and the crown 12 and between the first wall 6 and the base 10 in FIG. 2. Further, the transition zone 74 may be a curved transition zone 74, as shown with between the second wall 8 and the base 10 in FIG. 2. Also, the transition zone 74 may be an orthogonal transition zone 74, as shown with the second wall 8 and the crown 12 in FIG. 2, for example.

SOUND ABSORBING MATERIAL: The sound absorbing material 16 is preferably mineral wool, including glass wool, stone wool, and ceramic fiber wool. This helps to absorb noise sound waves and also, according to some embodiments, is robust against weather deterioration, has qualities of fire resistance, and reduces thermal heat conduction. The sound absorbing material 16 preferably occupies substantially all of the panel interior 14 that is not part of the at least one gaps 50. In some embodiments, as shown in FIG. 2, the sound absorbing material 16 does not occupy the feet 56 or the tongue 54. This allows for the sound absorbing material 16 to be much more quickly and easily mounted within the panel interior. The sound absorbing material 16 preferably occupies between 75% to 98% of the panel interior 14, more preferably occupies between 84% and 94% of the panel interior 14, even more preferably occupies between 87% and 91% of the panel interior 14, and most preferably occupies between 88.5% and 89.5% of the panel interior 14. In a cross section of the sound barrier panel 2, the sound absorbing material 16 preferably measures between 20.0 and 26.0 square inches, more preferably between 22.0 and 25.0 square inches, and most preferably between 23.5 and 24.0 square inches. The sound absorbing material 16 is preferably one continuous mat of acoustic mineral wool, but could be multiple units joined or placed together. The density of the sound absorbing material 16 is preferably between 3 pounds per cubic foot and 9 pounds per cubic foot, more preferably between 4 pounds per cubic foot and 8 pounds per cubic foot, and most preferably between 5.5 pounds per cubic foot and 6.5 pounds per cubic foot. The density of the sound absorbing material 16 could be constant throughout the sound absorbing material 16, or could have increasing, decreasing, or alternating densities across a cross section of the sound absorbing material 16, for example.

Though sound absorbing material 16 is preferred, according to a further embodiment, the sound barrier panel 2 may omit sound absorbing material 16 and/or preferably have an increased amount of sound diffusers 52 disposed on the interior surface 36 of the second wall 8.

MEASUREMENTS: The sound barrier panel 2 is preferably between 1.5 and 5.0 inches wide, more preferably between 2.0 inches and 3.5 inches wide, and most preferably between 2.25 inches and 2.75 inches wide. The sound barrier panel 2 is preferably between 6.0 inches and 24.0 inches in height, more preferably between 9.0 inches and 18.0 inches in height, even more preferably between 11.0 inches and 15.0 inches in height, and is most preferably approximately 12.0 inches in height, where the height is measured from the bottom of the base feet 56 to the top of the crown shoulder 62. The sound barrier panel 2 may be pultruded to a wide variety of lengths, as needed. Common lengths are preferably between 4 feet and 24 feet, more preferably between 8 feet and 18 feet, and most preferably between 12 feet and 15 feet. The cross sectional thickness of the respective walls 6, 8, base 10, and crown 12 are preferably between 0.07 inches and 0.3 inches, more preferably between 0.10 inches and 0.20 inches, and most preferably between 0.15 and 0.16 inches. The respective walls 6, 8, base 10, and crown 12 preferably have a common cross sectional thickness. The width is measured in the width direction 76 as indicated in FIG. 2. The length is measured in the lengthwise direction 32 as indicated in FIG. 1. The height is measured in the vertical direction 30 as indicated in FIG. 2, with the up and top direction being toward the top of the page (proximate to the crown 12 and the down direction being toward the bottom of the page (proximate to the base 10).

SYSTEM: To create the sound barrier system 4, a first and a second support columns 78, as shown in FIG. 1, are secured to a desired barrier location 80. A sound barrier panel 2 is then lowered between the two support columns 78 in respective panel mounting channels 82. Next, second, and further sound barrier panels 2 are lowered into the panel mounting channels 82 to mount tongue 54 and groove 64, one on top of another, until a desired height is reached. A cap (not shown) may be used to cap a top most sound barrier panel 2. If additional length in the wall of the sound barrier system 4 is desired, a third support column 78 would preferably be secured, and additional sound barrier panels 2 would be mounted between the second and the third support columns 78 in the respective panel mounting channels 82. This process would preferably be repeated until the desired span or perimeter (open or closed) of the wall of the sound barrier system 4 was created.

FUNCTIONING: As the noise from the excessive noise location 18 side of the sound barrier panel 2 approaches the sound barrier panel 2, a first portion of the nose sound waves strike the exterior surface 58 of the first wall 6, reflecting back toward the excessive noise location 18 side, and a second portion of the noise sound waves pass through the apertures 22 in the first wall 6. The apertures 22 allow noise sound waves to pass through the first wall 6, enter into the panel interior 14, and pass into the sound absorbing material 16. A portion of the noise sound waves will be absorbed by the sound absorbing material 16, and a reduced portion will pass through the sound absorbing material 16 and pass into the at least one gap 50. The sound waves, moving from the sound absorbing material 16 to the air in the at least one gap 50, may refract and fan out, potentially creating destructive interference and diffusion. When the noise sound waves then hit the interior surface 36 of the second wall 8, the majority of the noise sound waves will reflect off of the interior surface 36 of the second wall 8, move back through the air in the at least one gap 50 toward the first wall 6, and enter the sound absorbing material 16 again. Some of the noise sound waves will have reflected off the interior surface 36 of the second wall 8 at a high angle of incidence, causing the noise sound waves to pass through sound absorbing material 16 at a steeper angle (closer to vertical), effectively lengthening the path of the noise sound wave through the sound absorbing material 16 and increasing the amount of noise sound waves absorbed. Sound diffusers 52 on the interior surface 36 of the second wall 8 may act to increase the amount of noise sound wave diffusion when the noise sound waves strike the interior surface 36 of the second wall 8, increasing sound wave diffusion and potentially increasing sound wave interference and soundwave travel distance when reflecting back through the sound absorbing material 16.

The previously described embodiments and variations of the present invention have many advantages. Some of the advantages are high levels of sound absorption and low levels of sound transmission. Testing one embodiment of the sound barrier panels 2, the inventors measured Noise Reduction Coefficient (NRC) at 1.05 and the Sound Transmission Class (STC) 35.0. These tested levels were quite surprising to the inventors. Additionally, according to at least one embodiment, the sound barrier panels 2 and the sound barrier system 4 are strong enough to meet a large number of structural load requirements, while requiring respectively less foundations and steel support columns 78 or beams. The strength of the sound barrier panels 2 also surprised the inventors, as being especially strong for a sound barrier panel 2 that also has such high sound absorptive properties. Though various advantages and advantageous features have been described, the present invention does not require all of the advantageous features or all of the advantages to be included into every embodiment.

The invention illustratively disclosed herein suitably may explicitly be practiced in the absence of any element which is not specifically disclosed herein. While various embodiments of the present invention have been described in detail, it is apparent that various modifications and alterations of those embodiments will occur to and be readily apparent those skilled in the art. However, it is to be expressly understood that such modifications and alterations are within the scope and spirit of the present invention, as set forth in the appended claims. Further, the invention(s) described herein is capable of other embodiments and of being practiced or of being carried out in various other related ways. In addition, it is to be understood that the phraseology and terminology used herein is for the purpose of description and should not be regarded as limiting. The use of “including,” “comprising,” or “having” and variations thereof herein is meant to encompass the items listed thereafter and equivalents thereof as well as additional items while only the terms “consisting of” and “consisting only of” are to be construed in the limitative sense.

1. A sound barrier panel comprising:
a substantially planar first wall, with a plurality of apertures defined in the first wall;
a non-apertured second wall;
a crown connecting the first wall to the second wall,
a base connecting the first wall to the second wall,
a panel interior defined by a spacing between the first wall, the second wall, the crown, and the base;
a sound absorbing material disposed in the panel interior; and
the second wall being contoured such that at least one continuous gap is formed between an inner surface of the second wall and the sound absorbing material;
wherein the first wall, the second wall, the crown, and the base are formed of a pultruded material.

2. The sound barrier panel of claim 1 further comprising a tongue defined on one of the crown and the base, and a groove defined on the other of the crown and the base, wherein the tongue matingly fits within the groove.

3. The sound barrier panel of claim 2 wherein the tongue fits within the groove with a transition fit.

4. The sound barrier panel of claim 2 further comprising a shoulder adjacent to the tongue and a foot adjacent to the groove.

5. The sound barrier panel of claim 2 wherein the tongue is between one of one half and one third of the width of the sound barrier panel.

6. The sound barrier panel of claim 1 wherein the second wall has at least one indentation, the indentation spacing the sound absorbing material from a planar portion of the second wall creating the at least one gap.

7. The sound barrier panel of claim 1 wherein a sum volume of the at least one gaps preferably occupies between 3.0% and 35.0% of the panel interior.

8. The sound barrier panel of claim 1 wherein the apertures cover between 22% and 30% of a surface area of the first wall.

9. The sound barrier panel of claim 1 wherein the apertures are circular and have a diameter between 0.25 inches and 1.25 inches.

10. The sound barrier panel of claim 1 further comprising a plurality of uninterrupted wall columns of material on the first wall uninterrupted by apertures, the uninterrupted wall columns extending along the first wall from above an uppermost aperture to below a bottommost aperture.

11. The sound barrier panel of claim 10, wherein at least one of the plurality of uninterrupted wall columns is between ½ and 1 1/10 as wide as a diameter of the apertures.

12. The sound barrier panel of claim 1 wherein the sound barrier panel is flame resistant.

13. The sound barrier panel of claim 1 wherein the first wall, the second wall, the crown, and the base are formed of fiberglass.

14. The sound barrier panel of claim 1 wherein the sound absorbing material is mineral wool, and the sound absorbing material is adjacent to the first wall.

15. (canceled)

16. The sound barrier panel of claim 1 wherein the sound barrier panel has a Noise Reduction Coefficient (NRC) measurement of above 0.95 and a Sound Transmission Class (STC) measurement of above 30.0.

17. The sound barrier panel of claim 1 wherein the sound barrier panel measures between 1.5 inches and 5.0 inches wide, between 6.0 inches and 24.0 inches high, and between 4 feet and 24 feet long.

18. The sound barrier panel of claim 1 further comprising a phenolic coating over an exterior of the first wall, the second wall, the crown, and the base.

19. The sound barrier of claim 1 further comprising a plurality of acoustic diffusers formed on an interior surface of the second wall.

20. The sound barrier of claim 1, wherein a cross-section of the second wall has a shiplap shape.

21. A sound barrier panel comprising:
a substantially planar first wall, with a plurality of circular through apertures defined in the first wall, and covering between 22% and 30% of a surface area of the first wall
a non-apertured second wall;
a crown connecting the first wall to the second wall,
a base connecting the first wall to the second wall,
a panel interior defined by a spacing between the first wall, the second wall, the crown, and the base;
a sound absorbing material disposed in the panel interior; and
the second wall being contoured such that at least one continuous gap is formed between an inner surface of the second wall and the sound absorbing material;
wherein the first wall, the second wall, the crown, and the base
are formed of pultruded fiberglass,
are of unitary construction, and
with the exception of the apertures have a substantially fixed cross sectional profile.
